(19) United States
(12) Patent Application Publication
(10) Pub. No.: US 2007/0143286 A1
(43) Pub. Date: Jun. 21, 2007

(54) File management method in file system and metadata server therefor

(76) Inventors: Hong Yeon Kim, Daejeon-city (KR); Young Kyun Kim, Daejeon-city (KR); June Kim, Daejeon-city (KR); Myung Joon Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/634,483

(22) Filed: Dec. 6, 2006

(30) Foreign Application Priority Data
Dec. 8, 2005 (KR) 10-2005-0119483
May 17, 2006 (KR) 10-2006-0044257

(51) Int. Cl. G06F 17/30

(52) U.S. Cl. 707/6

(57) ABSTRACT

A file management method in a file system and a metadata server therefor are provided. The file management method in a file system includes: generating first metadata and a first object having an identical first identifier with respect to a first file; and finding second metadata and a second object corresponding to a second file desired to be found among a plurality of generated files, by using a second identifier, and if the second metadata and the second object are found, opening the second file.

### CROSS-REFERENCE TO RELATED PATENT APPLICATIONS

This application claims the benefit of Korean Patent Application No. 10-2005-0119483, filed on Dec. 8, 2005 and Korean Patent Application No. 10-2006-0044257, filed on May 17, 2006, in the Korean Intellectual Property Office, the disclosures of which are incorporated herein in their entirety by reference.

### BACKGROUND OF THE INVENTION

1. Field of the Invention

The present invention relates to a file management method in a file system and a metadata server therefor, and more particularly, to a method of managing files in order to maintain the structural consistency of a file system in a network-based asymmetric distributed file system using an object-based storage device (OSD), and a metadata server therefor.

2. Description of the Related Art

A file system is a data structure used by an operating system to make files continuous in a partition or on a disk, and dictates how files are arranged on a disk.

All file systems have their own unique storage structures and provide procedures for file system check and recovery (FSCR) in preparation for a fault. These FSCR procedures include a CHKDSK utility for the file allocation table (FAT) file system, a scandisk utility for the NT file system, and a fsck utility for ext2 and ext3 file systems.

The FSCR procedures should also be provided in an object storage device file system (OSDFS). The OSDFS has an asymmetric distributed file server structure in which a metadata server and a data server exist separately. That is, in the OSDFS structure, a metadata server (MDS) processing all metadata, a data server processing all data, and clients accessing these servers to provide file services are connected to each other through a network. The data server utilizes an object-based storage device (OSD). In this structure, the actual data of all files is distributed to and stored in a plurality of data servers, and object identifiers (IDs) of the data are stored in the metadata server together with other metadata of corresponding files, for example, file names, sizes, properties and owners. In this storage structure, a fault should not occur in any circumstances. However, in fact, due to the characteristics of the OSDFS system including a plurality of servers, a structural defect in recently changed items immediately after a fault occurs cannot be completely prevented. Accordingly, this type of structural defect should be identified and modified according to an appropriate FSCR procedure.

### SUMMARY OF THE INVENTION

The present invention provides a method of managing files which allows an asymmetric distributed file system using an object-based storage device (OSD) to manage and recover files by examining reference integrity with the OSD complying with an SCSI/OSD protocol, and a metadata server for performing the method.

According to an aspect of the present invention, there is provided a file management method in a file system including: generating first metadata and a first object having an identical first identifier with respect to a first file; and finding second metadata and a second object corresponding to a second file desired to be found among a plurality of generated files, by using a second identifier, and if the second metadata and the second object are found, opening the second file.

According to another aspect of the present invention, there is provided a metadata server including: a generation unit adapted to generate metadata and an object with respect to a file to be generated; a storage unit adapted to store the metadata; a storage management unit adapted to store the metadata in the storage unit, storing the object in an external unit, and managing the metadata and the object; and a fault recovery unit adapted to detect errors with respect to the metadata or the object when the metadata and the object are generated by the generation unit, or when the metadata and the object are managed by the storage management unit, and recover from the errors.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating a configuration of an object storage device file system (OSDFS) to which an embodiment of the present invention is applied;

FIG. 2 is a detailed diagram of the OSDFS illustrated in FIG. 1;

FIG. 3A illustrates metadata with respect to each file stored in a storage unit of a metadata server (MDS);

FIG. 3B illustrates an object which is stored in the storage unit of an object-based storage device (OSD) and is referred to by metadata with respect to a file corresponding to the object;

FIG. 4 is a flowchart illustrating a process in which metadata or an object is changed and recorded in each storage unit by a client unit;

FIGS. 5A through 5C illustrate errors that can occur in an OSDFS in which metadata or an object is changed according to the process illustrated in FIG. 4;

FIG. 6 is a flowchart illustrating an object generating process performed by an interoperation of a generation unit and a fault recovery unit illustrated in FIG. 2;

FIG. 7 is a flowchart illustrating a file deleting process performed in a storage management unit illustrated in FIG. 2; and

FIG. 8 is a flowchart illustrating a file opening process performed by an interoperation of a storage management unit and a fault recovery unit illustrated in FIG. 2.

### DETAILED DESCRIPTION OF THE INVENTION

The present invention will now be described more fully with reference to the accompanying drawings, in which exemplary embodiments of the invention are shown.

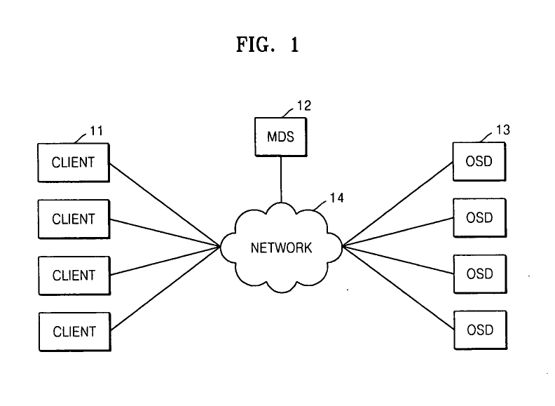

FIG. 1 is a schematic diagram illustrating a configuration of an object storage device file system (OSDFS) to which an embodiment of the present invention is applied. The OSDFS illustrated in FIG. 1 includes a plurality of clients 11, a metadata server (MDS) 12, and a plurality of object-based storage devices (OSDs) 13 that are connected to a network 14.

The MDS 12 generates, stores, and manages a variety of metadata used in the OSDFS system. The MDS 12 should have a metadata storage apparatus (not shown) of its own together with a metadata processing module in order to store and manage the metadata. The storage apparatus may be a file system, such as ext2, ext3 or xfs, or may be a database management system (DBMS), and has a file system check and recovery (FSCR) procedure of its own so that the consistency of the stored metadata can be recovered when a fault occurs.

The OSDs 13 are a plurality of physical storage apparatuses connected to the network 14. An OSD 13 uses intelligent storage technology which is in the fledgling stage in the storage field. Unlike most existing block-based storage apparatuses, such as hard disks for personal computers (PCs) and CD-ROMs, the OSD 13 stores object-based data. The OSD 13 can perform an input/output function and a recovery function as well as a function for managing a plurality of objects in the storage unit. In particular, the recovery function in the OSD 13 has a fault recovery procedure for internal metadata in order to manage objects, and according to this function, when a fault occurs in the OSD 13, the consistency of the object storage structure of the OSD 13 can be recovered by itself.

In order to input data to and output data from the OSD 13, the small computer system interface (SCSI)/OSD protocol is used. This protocol is a standard for a next-generation intelligent storage led by storage providers and their association, the storage network industry association (SNIA). This protocol can be operated through an Internet SCSI (iSCSI) interface apparatus and an FC-SCSI interface apparatus as well as the SCSI interface apparatus.

The network 14 can be a local area network (LAN), a wide area network (WAN), a wireless network, or any other arbitrary network enabling communications between hardware devices, and is used for communications among the clients 11, the MDS 12 and the OSDs 13 in the current embodiment.

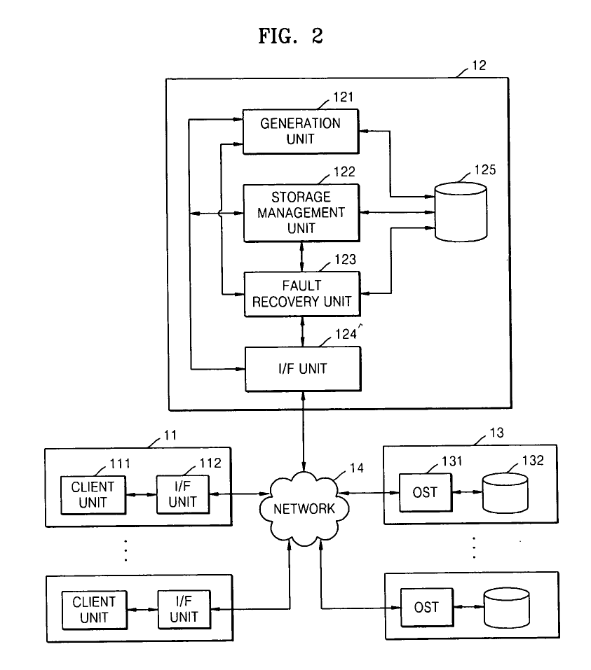

FIG. 2 is a detailed diagram of the OSDFS illustrated in FIG. 1.

The client 11 is composed of a client unit 111 and an interface unit 112.

The client unit 111 accesses the MDS 12 or the OSD 13 through the network 14 according to an operating system. The interface unit 112 includes an iSCSI/OSD initiator which processes input and output operations so that the client unit 11 can directly access the OSD 13 through the network 14, and a remote procedure call (RPC) protocol interfacing the client unit 111 with the MDS 22 so that the client unit 111 can access the MDS 22.

The MDS 12 includes a generation unit 121, a storage management unit 122, a fault recovery unit 123, an interface unit 124 and a storage unit 125. The generation unit 121 generates metadata and objects with respect to a file. The storage management unit 122 stores and manages all metadata used in the OSDFS system. Each of directories and file objects has an index node, namely, Inode indicating its own attribute. An Inode stores the logical size of a file, the owner of the file, access rights, and an identifier for an object on an OSD 13 which actually stores the data of the file. The fault recovery unit 123 recovers consistency of the file system when a fault occurs in the clients 11, the MDS 12, and the OSDs 13. This function may be activated manually, or automatically when a system monitoring software detects a fault or at a predetermined period. Depending on the actual the implementation, during operation of this function, access of all clients 11 may be prohibited, or in order to improve the availability of the OSDFS system, access of all clients 11 may be permitted.

The detailed operation of the fault recovery unit 123 will be explained later in more detail.

The interface unit 124 transfers an MDS access request received from the client unit 111 through the RPC protocol, to the generation unit 121, the storage management unit 122, and the fault recovery unit 123, and outputs the result of the request to the client unit 111. Also, through the iSCSI/OSD initiator, the interface unit 124 allows the generation unit 121, the storage management unit 122, and the fault recovery unit 123 to access the OSD 13. The storage unit 125 stores all metadata generated in the generation unit 121 and managed in the storage management unit 122. For this, the storage unit 125 uses the journaling based ext3 file system.

The OSD 13 includes an object storage target (OST) 131 and a storage unit 132. The OST 131 receives SCSI/OSD commands transferred by the client unit 111, the generation unit 121, the storage management unit 122 or the fault recovery unit 123, and interprets and processes the commands. The storage unit 132 stores objects input or output by the OST 131 and uses the journaling based ext3 file system.

An explanation of some SCSI/OSD commands is shown in table 1 below:

TABLE 1

| Commands | OP code | Service action |
|---|---|---|
| CREATE | 7Fh | 8802h |
| CREATE COLLECTION | 7Fh | 8815h |
| CREATE PARTITION | 7Fh | 880Bh |
| FLUSH OBJECT | 7Fh | 8808h |
| GET ATTRIBUTES | 7Fh | 880Eh |
| LIST | 7Fh | 8803h |
| LIST COLLECTION | 7Fh | 8817h |
| READ | 7Fh | 8805h |
| REMOVE | 7Fh | 880Ah |
| REMOVE COLLECTION | 7Fh | 8816h |
| REMOVE PARTITION | 7Fh | 880Ch |
| SET ATTRIBUTES | 7Fh | 880Ff |
| WRITE | 7Fh | 8806h |

In table 1, h indicates a hexadecimal number. Among the commands, CREATE generates a new object, GET_ATTRIBUTES obtains attributes of an object, REMOVE deletes an object, and SET_ATTRIBUTES sets properties of an object.

FIG. 3A illustrates metadata with respect to each file stored in the storage unit 126 of the MDS 12, and FIG. 3B illustrates an object which is stored in the storage unit 132 of the OSD 13 and is referred to by metadata for a file corresponding to the object. As shown in FIGS. 3A and 3B, an Inode includes a file identifier, a location on a disk to which file data is stored, a file owner, a group, an access right, a file access, an amendment and modification time, etc. The Inode is generated when a new file is generated, and is deleted when an existing file is deleted.

Each of the storage units 126 and 132 includes a temporary storage unit (not shown) and a permanent storage unit (not shown). Here, the temporary storage unit is a memory device having a faster access time than the permanent storage unit.

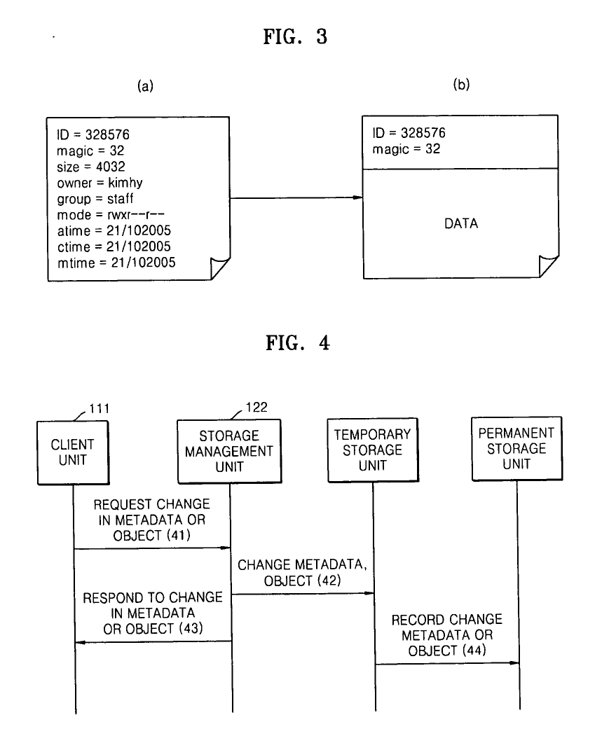

FIG. 4 is a flowchart illustrating a process in which metadata or an object is changed and recorded in each storage unit 125 and 132 by the client unit 111.

If an arbitrary change request from the client unit 111 is transferred to the storage management unit 122 or the OST 131 through the interface unit 112 in operation 41, the storage management unit 122 or the OST 131 processes the change request in the temporary storage unit in operation 42, and outputs the processing result to the client unit 111 in operation 43. The processing result stored in the temporary storage unit is recorded in the permanent storage unit after a predetermined time in operation 44. This process for changing the metadata or object has a positive function for improving the performance of the entire system, but when a fault occurs, recently changed information that has not yet been recorded in the permanent storage unit is lost, causing an error in the referencing between the metadata and object.

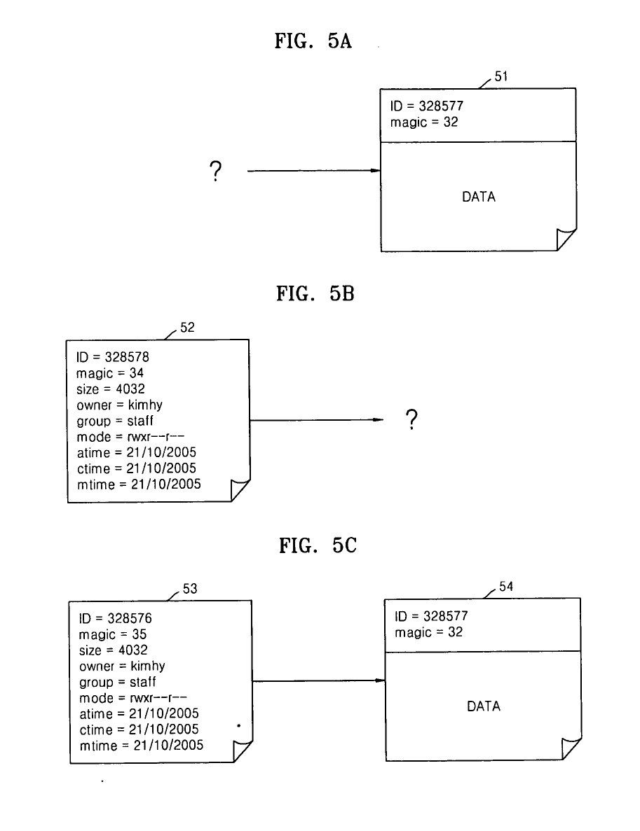

FIGS. 5A through 5C illustrate errors that can occur in an OSDFS system in which metadata or an object is changed according to the process illustrated in FIG. 4.

FIG. 5A illustrates an example of a remnant orphan object error. The remnant orphan object error indicates an object 51 which exists but is not referred to by any metadata. This error occurs when an object generated in a process of generating a file is stored in the permanent storage unit of the storage unit 132, then the metadata is deleted, but, before the deleting of the metadata is reflected in the permanent storage unit of the storage unit 125, a fault occurs in the MDS 12. This error also occurs in the file deleting process when the result of deleting the metadata is reflected in the permanent storage unit of the storage unit 125, but before the deletion of the object information is reflected in the permanent storage unit, a fault occurs in the OSD 13. In either case, the remnant orphan object makes the corresponding area in the storage units 125 and 132 permanently unusable. Accordingly, the remnant orphan object must be prevented or effectively removed.

FIG. 5B illustrates an example of a non-existent object reference error. The non-existent object reference error indicates metadata 52 refers to a non-existent object. This error occurs in the file generating process when metadata of a generated file is reflected in the permanent storage unit of the storage unit 125, but before the generated object is reflected in the permanent storage unit of the storage unit 132, a fault occurs in the OSD 13. This error also occurs in the file deleting process when deleted object information is reflected in the permanent storage unit of the storage unit 132, but before the metadata is reflected in the permanent storage unit of the storage unit 125, a fault occurs in the MDS 12.

FIG. 5C illustrates an example of an incorrect object reference error. The incorrect reference error indicates an object 54 referred to by the metadata 53 of a predetermined file is not its own object of that file. This error occurs when an object corresponding to a predetermined file has an identical identifier with an object having been used before and a fault occurs in the OSD 13 after the file generation and deletion processes are performed consecutively.

In order to solve the errors illustrated in FIGS. 5A through 5C, interoperating with the fault recovery unit 123, the generation unit 121 generates objects, metadata or metadata identifiers as follows.

First, when a file is generated, metadata is generated and an object is generated in the OSD 13 with the same value as the identifier of the metadata. In this way, an identifier of an object corresponding to the metadata of a file does not need to be maintained. Whether an object reference error for a predetermined metadata exists can be determined according to whether an object having an identical identifier with the metadata exists. Also, since the arrangement and order of metadata identifiers exactly match those of the corresponding object identifier, comparison of both sides is very easy.

Second, as a metadata identifier, the smallest unused identifier of 16 or 32 bits is used first, and the metadata identifier of a deleted file is reused when another file is generated. Accordingly, even if a fault causes an orphan object in a file generating or deleting process, when a new file is generated after the fault, an object is generated with the identifier of the orphan object and thus the orphan object can be removed or recovered.

Third, every one of metadata has a magic code together with a metadata identifier. The magic code is used in order to solve the incorrect object reference error problem where newly generated metadata refers to an object deleted immediately before. The magic code is a special code value generated whenever a file is generated, and is assigned to both the metadata and the object corresponding to the metadata as an attribute value. Accordingly, an object corresponding to predetermined metadata should have the same identifier as the metadata, and should also have the same magic code as the metadata. This can prevent the error in which an object for a file deleted immediately before is used for a newly generated file.

The magic code described above can be generated in a variety of ways. For example, a random number, a clock, or a global counter counting whenever generating a file can be used. Also, a counter may be assigned for each metadata identifier, and whenever the corresponding metadata identifier is used for the file generation, the counter corresponding to the identifier can be increased to generate a magic code. In any case, the magic code can be used to guarantee that metadata and an object corresponding to the metadata are generated at the same time.

By using the metadata and the metadata identifier and interoperating with the storage management unit 122, the fault recovery unit 123 recovers from each error.

First, recovery from a non-existent object reference error is automatically performed by the fault recovery unit 123 when the storage management unit 122 opens a predetermined file. In the recovery process, it is determined whether an object exists with the same identifier as the metadata identifier corresponding to the file to be opened, and if no such object exists, a new object with the same identifier is generated.

Recovery from an incorrect object reference error is automatically performed by the fault recovery unit 123 when the storage management unit 122 opens a predetermined file. In the recovery process, if an object exists with the same identifier as the metadata identifier corresponding to the file to be opened, the magic codes of the metadata and the object are compared, and if the magic codes are different from each other, the existing object is deleted and a new object is generated.

Recovery from a remnant orphan object error is automatically performed by the fault recovery unit 123 when the generation unit 121 generates a file. In the recovery process, it is determined whether an object exists with the same identifier as the metadata identifier corresponding to the generated file, and if the object exists it is removed.

In addition, a whole error check and recovery after a fault is performed by the fault recovery unit 123. In this process, the fault recovery unit 123 compares metadata identifiers with all object identifiers in the OSD 13 one-by-one at a time or sequentially, and determines a identifier that does not commonly exist in both sides as a reference error.

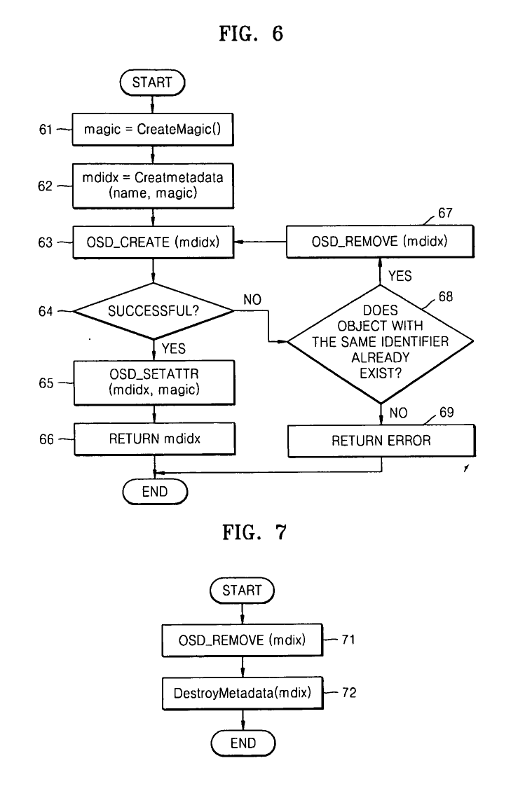

FIG. 6 is a flowchart illustrating an object generating process performed by interoperation of the generation unit 121 and the fault recovery unit 123.

First, a magic code unique to a file to be generated is obtained in operation 61. The magic code can be selected from among random numbers generated by the MDS 12, a clock provided to the MDS 12, a global counter, or a counter for each one of metadata, as described above. Then, metadata for the file to be generated is generated using a given name and the magic code, and an identifier for the metadata is obtained in operation 62. The magic code is stored within the generated metadata. Then, an object is generated with the same identifier as the metadata, by using the CREATE SCSI/OSD command in operation 63. If operation 63 is not successful (operation 64) due to an already-existing identical identifier for the object in operation 68, the object is removed by using the REMOVE SCSI/OSC command in operation 67 and operation 63 is performed again. If operation 63 is not successful with the reason not described in operation 68, it indicates that the file generation has failed. Accordingly, an error is returned in operation 69 and the process is finished. If the generation of the object is successful in operation 64, by using the SET_ATTRIBUTE SCSI/OSD command (SETATTR), a magic code of metadata is set as a user attribute of the generated object in operation 65, and the generated metadata identifier is returned in operation 66.

FIG. 7 is a flowchart illustrating a file deleting process performed in the storage management unit 122.

In the file deleting process, first, the object of the file to be deleted is removed using OSD_REMOVE in operation 71. Then, the metadata of the file to be deleted is removed and the file deletion is completed in operation 72.

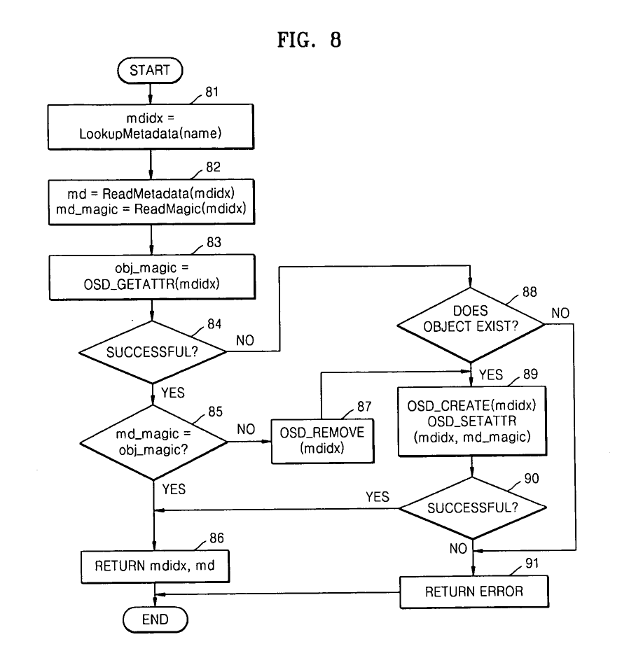

FIG. 8 is a flowchart illustrating a file opening process performed by interoperation of the storage management unit 122 and the fault recovery unit 123.

First, a metadata identifier corresponding to the file of a given name is searched for in operation 81 and the metadata and magic code corresponding to the metadata identifier are obtained in operation 82. Then, by using the GETATTR SCSI/OSD command, it is confirmed that an object having the same identifier as the metadata identifier exists in the storage unit 132 of the OSD 13 and the magic code attribute value set to the object matches the magic code of the metadata corresponding to the file in operation 83. If no such object exists and thus an error occurs in operations 83 and 84, an object is generated with the same identifier as the metadata identifier and the magic code of the metadata is set to the object as a user attribute in operation 89. If the generation of the new object and setting of the magic code in operation 89 are successful in operation 90, the metadata (md) and metadata identifier (mdidx) are returned and thus opening of the file is completed in operation 86.

If the object having the identical identifier exists in operation 84 but the magic code of the metadata does not match the magic code value of the object in operation 85, the object is removed in operation 87. Then, a new object is generated with the same identifier as the metadata identifier, and the magic code of the metadata is assigned to the object as a user attribute in operation 89. If the generation of the new object and setting of the magic code in operation 89 are successful in operation 90, the metadata (md) and metadata identifier (mdidx) are returned and thus opening of the file is completed in operation 86.

If the object having the same identifier exists and the magic code of the metadata also matches the magic code of the object in operation 85, the metadata (md) and metadata identifier (mdidx) are returned and thus opening of the file is completed in operation 86.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

The present invention can increase device compatibility because the present invention can be implemented in any storage apparatus complying with the SCSI/OSD standard.

Also, even if a system is reactivated without a separate recovery process after a fault, there can be no trouble with the system operation. Accordingly, the system can recover gradually from a variety of types of reference error.

In addition, since no additional load is required to cope with a fault in a normal operation process, better performance can be expected than that of the conventional technology. That is, the conventional system requires the additional loads for preparing additional logs for both the MDS and OSD, and in order to check whether the contents of permanent storage devices of both sides are correctly reflected, a separate protocol is used to synchronize both sides. The present invention does not need these loads and thus does not burden the normal operation process.

While the present invention has been particularly shown and described with reference to exemplary embodiments thereof, it will be understood by those of ordinary skill in the art that various changes in form and detail may be made therein without departing from the spirit and scope of the present invention as defined by the following claims. The preferred embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. A file management method comprising:
generating first metadata and a first object having an identical first identifier with respect to a first file; and
finding second metadata and a second object corresponding to a second file desired to be found among a plurality of generated files, by using a second identifier, and if the second metadata and the second object are found, opening the second file.

2. The method of claim 1, wherein the generating first metadata and a first object comprises:
obtaining a magic code with respect to the first file;
generating the first metadata by using a name of the first file and the magic code, and obtaining the first identifier with respect to the first metadata; and
generating the first object having a same identifier as the first identifier.

3. The method of claim 2, further comprising:
if a third object having a same identifier as the first identifier already exists and thus the first object is not generated, removing the third object; and
generating the first object having the same identifier as the first identifier.

4. The method of claim 2, further comprising assigning the magic code as a user attribute of the first object.

5. The method of claims 2, wherein the magic code is one of a random number, a clock, a current value of a global counter which increments by 1 whenever the first metadata is generated, and a current value of a counter which increments by 1 whenever the first identifier is assigned to a file being generated.

6. The method of any one of claim 1, wherein a small computer system interface/object-based storage device (SCSI/OSD) command is used to perform each operation.

7. The method of claim 1, wherein the opening the second file comprises:
searching for the second identifier corresponding to the second file to obtain the second metadata and a magic code;
searching for a third object having a same identifier as the second identifier and determining whether the magic code attribute value of the third object matches the magic code; and
if the magic code attribute value matches the magic code, confirming the third object to be the second object and opening the second file.

8. The method of claim 7, wherein the searching for a third object comprises:
if the third object does not exist, generating a fourth object having a same identifier as the second identifier; and
setting the magic code of the second metadata as a magic code attribute of the fourth object.

9. The method of claim 7, wherein the determination of whether the magic code attribute value of the third object matches the magic code is performed using an SCSI/OSD command.

10. The method of claim 7, wherein the determining of whether the magic code attribute value of the third object matches the magic code comprises:
if the third object exists but the magic code attribute value of the third object does not match the magic code, removing the third object;
generating a fourth object having a same identifier as the second identifier; and
assigning the magic code of the second metadata as a magic code attribute of the fourth object.

11. The method of claim 1, further comprising:
removing an object of a third file to be deleted; and
removing metadata of the third file so that the third file is removed.

12. The method of claim 1, further comprising:
obtaining the identifiers of the objects at a time or sequentially and comparing the identifiers with the identifiers of the metadata one-by-one; and
according to the comparison results, determining identifiers that do not exist commonly at both sides as errors.

13. A metadata server comprising:
a generation unit adapted to generate metadata and an object with respect to a file to be generated;
a storage unit adapted to store the metadata;
a storage management unit adapted to store the metadata in the storage unit, storing the object in an external unit, and managing the metadata and the object; and
a fault recovery unit adapted to detect errors with respect to the metadata or the object when the metadata and the object are generated by the generation unit, or when the metadata and the object are managed by the storage management unit, and recover from the errors.

14. The server of claim 13, wherein in order to manage the object stored in the external unit, the generation unit, the storage management unit and the fault recovery unit communicate with the external unit using an SCSI/OSD protocol.

15. The server of claim 13, wherein the generation unit generates the metadata and object having identical identifiers with respect to the file.

16. The server of claim 14, wherein the generation unit generates the metadata and the object by performing:
obtaining a magic code with respect to the file;
generating the metadata by using a name of the file and the magic code, and obtaining the identifier with respect to the metadata; and
generating the object having a same identifier as the identifier.

17. The server of claim 13, wherein the storage management unit performs:
searching for an identifier corresponding to a file to be searched and obtaining second metadata and a magic code; and
searching for a second object having a same identifier as the identifier and determining whether a magic code attribute value of the second object matches the magic code,
wherein the file to be searched is opened if the magic code attribute value matches the magic code.
